(19) United States
(12) Patent Application Publication
(10) Pub. No.: US 2023/0128044 A1
(43) Pub. Date: Apr. 27, 2023

(54) METHOD, APPARATUS AND COMPUTER-READABLE RECORDING MEDIUM FOR SUPPORTING PRODUCTION OF CUSTOMIZED COSMETIC PRODUCT

(71) Applicant: MayCoders, INC., Seoul (KR)

(72) Inventors: Saemi CHOI, Seoul (KR); Seokjin HONG, Seoul (KR)

(21) Appl. No.: 17/531,585

(22) Filed: Nov. 19, 2021

(30) Foreign Application Priority Data
Oct. 25, 2021 (KR) 10-2021-0142859

(51) Int. Cl. G06Q 30/06; G06Q 50/04

(52) U.S. Cl. CPC G06Q 30/0621; G06Q 30/0631; G06Q 30/0643; G06Q 50/04

(57) ABSTRACT

Provided is a method for supporting production of a customized cosmetic product, the method including: an interface provision step of providing an interface for the production of the customized cosmetic product to a user terminal; a first decision-making step of determining a container design of the customized cosmetic product by collecting a first interaction value for a container design option of the customized cosmetic product through the interface; a second decision-making step of determining a label design of the customized cosmetic product by collecting a second interaction value for a label design option of the customized cosmetic product through the interface; and an order referral generation step of collecting a third interaction value for attribute information of a content of the customized cosmetic product through the interface, and generating an order referral for the production of the customized cosmetic product based on the collected first to third interaction values.

### BACKGROUND OF THE INVENTION

### 1. Field of the Invention

The present invention relates to a method for supporting production of a customized cosmetic product, and more particularly, to a technology for supporting production of a prototype of a customized cosmetic product to be commercialized by a user based on a sales power of a commercial cosmetic product and a consumer experience of using the commercial cosmetic product.

### 2. Description of the Related Art

As the Korean beauty industry is spotlighted from all over the world, interest in the Korean cosmetic industry has been increased to the extent that the term “K-beauty” is newly coined.

Accordingly, the government has been making various efforts to promote the K-beauty industry, including designating K-beauty as one of the ten core tasks in July 2021.

Meanwhile, conventional domestic cosmetic products have been generally produced through mass production that is collectively performed by manufacturers equipped with production facilities. Accordingly, small cosmetic manufacturers, individuals who desire to produce their own cosmetic products, and the like have been experiencing great difficulties in producing a prototype because of the absence of a production facility or the lack of expertise in production of cosmetic products.

In order to solve the above problems, Korean Unexamined Patent Publication No. 10-2021-0035461 proposes a technology related to a collaboration system for new product planning, development, and production of a cosmetic product, which enables production of a customized cosmetic product designed directly by a customer.

However, the above-described related art discloses merely a technical feature that intermediaries a cosmetic manufacturer capable of implementing an idea of the customer, so that a participation rate for customers to directly perform product design of a cosmetic product by using their own terminals or to control attribute values of the cosmetic product was low, and particularly, it is impossible to predict and view a result of the customized cosmetic product to be produced even though the customer has provided the idea.

### SUMMARY OF THE INVENTION

Accordingly, a first object of the present invention is to support production of a prototype of a customized cosmetic product to be commercialized by a user based on a sales power of a commercial cosmetic product and a consumer experience of using the commercial cosmetic product.

In addition, a second object of the present invention is to propose a customizing scheme with high actual product reproducibility by providing a mock-up image of a customized cosmetic product according to a selection input of a user terminal when an order for producing a prototype of the customized cosmetic product is performed in the user terminal.

To achieve the objects described above, a method for supporting production of a customized cosmetic product, which is implemented in a computing device including at least one processor and at least one memory for storing instructions that are executable by the processor, includes: an interface provision step of providing an interface for the production of the customized cosmetic product to a user terminal when the user terminal is connected to a platform server configured to support the production of the customized cosmetic product; a first decision-making step of determining a container design of the customized cosmetic product by collecting a first interaction value of a user for a container design option of the customized cosmetic product through the interface provided to the user terminal and providing a container modeling result of the customized cosmetic product corresponding to the first interaction value; a second decision-making step of determining, when the container design of the customized cosmetic product is determined, a label design of the customized cosmetic product by collecting a second interaction value of the user for a label design option of the customized cosmetic product through the interface and providing a result of layering a label modeling result corresponding to the second interaction value on the determined container design of the customized cosmetic product; and an order referral generation step of collecting a third interaction value of the user for attribute information of a content of the customized cosmetic product through the interface, and generating an order referral for the production of the customized cosmetic product based on the collected first to third interaction values.

When the third interaction value is collected, the attribute information of the content of the customized cosmetic product may be preferably provided in a plurality of clusters on the interface, and each of the clusters may preferably include a scale bar for guiding a relative criterion for the attribute information, and display a commercial cosmetic product having similar attribute information as indirect information in response to a third interaction of the user with the scale bar.

In addition, the clusters may be preferably obtained by collecting attribute information of a content of a commercial cosmetic product evaluated in at least one consumer terminal having an experience of purchasing the commercial cosmetic product, and clustering the collected attribute information.

In addition, the scale bar may preferably include an input field in which the relative criterion for the attribute information is subdivided into at least one level, and commercial cosmetic products having differential attribute information may be preferably displayed as the indirect information according to the third interaction of the user with at least one input field to support decision making on an attribute value of the customized cosmetic product produced in the user terminal.

In addition, the platform server may be preferably configured to: obtain a response for a product group of the customized cosmetic product to be produced in the user terminal by performing a query on the product group of the customized cosmetic product to be produced in the user terminal through the interface, before performing the first decision-making step; and differentiate sample designs for the container design and the label design to be provided in the first decision-making step and the second decision-making step according to the response for the product group of the customized cosmetic product.

In addition, the platform server may be preferably configured to: collect information on a target area of the customized cosmetic product from the user terminal through the interface, before performing the first decision-making step; and propose a recommended product group of the customized cosmetic product to be produced in the user terminal by analyzing collected data including at least one of electronic commerce data, real transaction data, and metadata on a social network service for a commercial cosmetic product in the target area.

In addition, the container design option provided through the interface in the first decision-making step may preferably include an option value obtained by extracting a design element including at least one of a size, a proportion, an opening/closing type, and a color of a container by analyzing a container image of a commercial cosmetic product belonging to a product group that is similar to a product group of the customized cosmetic product, and combining at least one extracted design element.

In addition, the label design option provided through the interface in the second decision-making step may preferably include an option value obtained by extracting a design element including at least one of a size of a label, a layout between objects constituting the label, and a color pattern by analyzing a label design of a commercial cosmetic product belonging to a product group that is similar to a product group of the customized cosmetic product, and combining at least one extracted design element.

Meanwhile, an apparatus for supporting production of a customized cosmetic product, which is implemented in a computing device including at least one processor and at least one memory for storing instructions that are executable by the processor, includes: an interface provision unit for providing an interface for the production of the customized cosmetic product to a user terminal when the user terminal is connected to a platform server configured to support the production of the customized cosmetic product; a first decision-making unit for determining a container design of the customized cosmetic product by collecting a first interaction value of a user for a container design option of the customized cosmetic product through the interface provided to the user terminal and providing a container modeling result of the customized cosmetic product corresponding to the first interaction value; a second decision-making unit for determining, when the container design of the customized cosmetic product is determined, a label design of the customized cosmetic product by collecting a second interaction value of the user for a label design option of the customized cosmetic product through the interface and providing a result of layering a label modeling result corresponding to the second interaction value on the determined container design of the customized cosmetic product; and an order referral generation unit for collecting a third interaction value of the user for attribute information of a content of the customized cosmetic product through the interface, and generating an order referral for the production of the customized cosmetic product based on the collected first to third interaction values.

Meanwhile, there is provided a computer-readable recording medium for storing instructions that allows a computing device to: an interface provision step of providing an interface for the production of the customized cosmetic product to a user terminal when the user terminal is connected to a platform server configured to support the production of the customized cosmetic product; a first decision-making step of determining a container design of the customized cosmetic product by collecting a first interaction value of a user for a container design option of the customized cosmetic product through the interface provided to the user terminal and providing a container modeling result of the customized cosmetic product corresponding to the first interaction value; a second decision-making step of determining, when the container design of the customized cosmetic product is determined, a label design of the customized cosmetic product by collecting a second interaction value of the user for a label design option of the customized cosmetic product through the interface and providing a result of layering a label modeling result corresponding to the second interaction value on the determined container design of the customized cosmetic product; and an order referral generation step of collecting a third interaction value of the user for attribute information of a content of the customized cosmetic product through the interface, and generating an order referral for the production of the customized cosmetic product based on the collected first to third interaction values.

According to one embodiment of the present invention, the production of the prototype of the customized cosmetic product to be commercialized by the user may be supported based on the sales power of the commercial cosmetic product and the consumer experience of using the commercial cosmetic product, so that a convenience of producing the customized cosmetic product can be increased.

In addition, according to one embodiment of the present invention, even when a user producing a customized cosmetic product does not have expertise about cosmetic product production or cosmetic product attributes, the production of the customized cosmetic product to be produced by the user can be supported by clearly recognizing the needs of the user.

Further, according to one embodiment of the present invention, the customizing scheme with the high actual product reproducibility can be proposed by providing the mock-up image of the customized cosmetic product according to the selection input of the user terminal when the order for producing the prototype of the customized cosmetic product is performed in the user terminal, so that user satisfaction of using a service can be significantly improved.

### BRIEF DESCRIPTION OF THE DRAWINGS

FIG. 1 is a flowchart of a method for supporting production of a customized cosmetic product according to one embodiment of the present invention.

FIGS. 2 to 7 are views showing examples of providing an interface for supporting the production of the customized cosmetic product according to one embodiment of the present invention.

FIG. 8 is a block diagram of an apparatus for supporting production of a customized cosmetic product according to one embodiment of the present invention.

FIG. 9 is a view showing one example of an internal configuration of a computing device according to one embodiment of the present invention.

### DETAILED DESCRIPTION OF THE INVENTION

Hereinafter, various embodiments and/or aspects will be disclosed with reference to the drawings. In the following description, for the purpose of explanation, numerous specific details are set forth in order to provide a thorough understanding of one or more aspects. However, it shall also be appreciated by a person having ordinary skill in the art to which the present invention pertains that such aspect(s) may be practiced without the specific details. The following description and the accompanying drawings will be set forth in detail for specific illustrative aspects among the one or more aspects. However, the aspects are provided for illustrative purposes, some of various schemes based on principles of various aspects may be employed, and descriptions set forth herein are intended to include all the various aspects and equivalents thereof.

The terms “embodiment”, “example”, “aspect”, “illustration”, and the like used herein may not be construed as indicating that an aspect or design set forth herein is preferable or advantageous over other aspects or designs.

In addition, it is to be understood that the terms “include” and/or “comprise” indicate the presence of corresponding features and/or elements, but do not preclude the presence or addition of one or more other features, components, and/or groups thereof.

Further, although the terms including an ordinal number such as “first” or “second” may be used to describe various elements, the elements are not limited by the terms. The above terms are used merely for the purpose of distinguishing one element from another element. For example, a first element may be termed as a second element, and similarly, a second element may also be termed as a first element without departing from the scope of the present invention. The term “and/or” includes any combination of a plurality of described relevant items, or one of the described relevant items.

In addition, in embodiments of the present invention, unless defined otherwise, all terms used herein, including technical and scientific terms, have the same meaning as those commonly understood by a person having ordinary skill in the art to which the present invention pertains. Any terms as those defined in generally used dictionaries are to be interpreted to have the meanings equal to the contextual meanings in the relevant field of art, and are not to be interpreted to have idealistic or excessively formalistic meanings unless explicitly defined in the embodiments of the present invention.

The present invention relates to a method for supporting production of a customized cosmetic product. In particular, a first object of the present invention is to support production of a prototype of a customized cosmetic product to be commercialized by a user based on a sales power of a commercial cosmetic product and a consumer experience of using the commercial cosmetic product, and a second object of the present invention is to propose a customizing scheme with high actual product reproducibility by providing a mock-up image of a customized cosmetic product according to a selection input of a user terminal when an order for producing a prototype of the customized cosmetic product is performed in the user terminal.

Meanwhile, the present invention for achieving the above-described objects will be described in more detail below with reference to the accompanying drawings, and a plurality of drawings may be simultaneously referenced in order to describe one technical feature and elements constituting the invention.

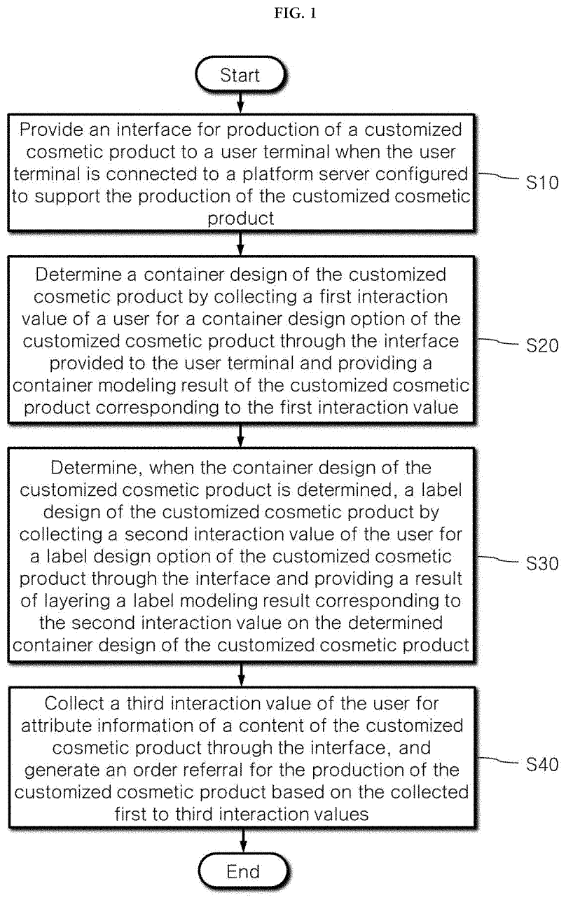

Referring to FIG. 1, FIG. 1 is a flowchart of a method for supporting production of a customized cosmetic product according to one embodiment of the present invention.

As shown in FIG. 1, according to the present invention, an interface provision step S10 of providing an interface for the production of the customized cosmetic product to a user terminal may be performed when the user terminal is determined as being connected to a platform server configured to support the production of the customized cosmetic product.

In this case, the interface may be implemented in the form of a web page, and the user terminal may be understood as a concept of a terminal including one of a wired/wireless telephone, a tablet PC, a laptop, a smartphone, a personal digital assistant, and a mobile communication terminal, which are capable of network communication.

Meanwhile, after the step S10 described above is performed, a first decision-making step S20 of determining a container design of the customized cosmetic product by collecting a first interaction value of a user for a container design option of the customized cosmetic product through the interface provided to the user terminal and providing a container modeling result of the customized cosmetic product corresponding to the first interaction value may be performed.

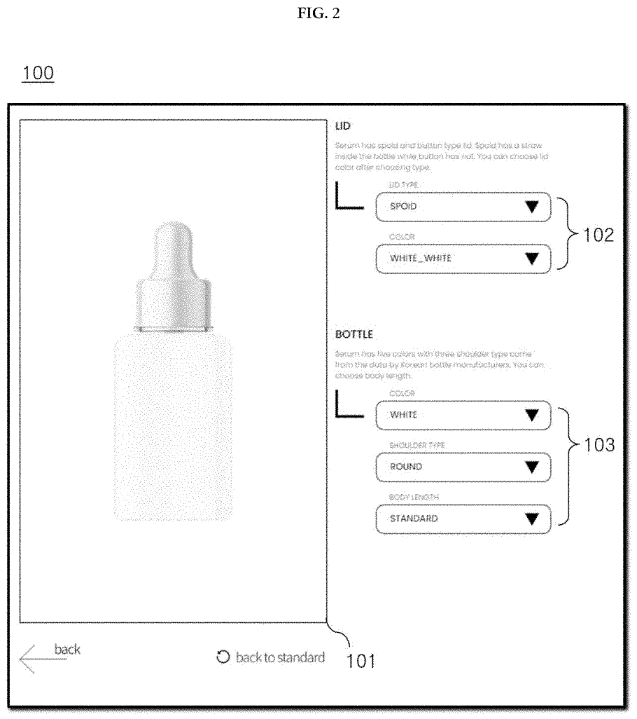

Referring simultaneously to 100 of FIG. 2, one region of the interface may include a canvas region 101 for providing the container design option according to the first interaction value of the user as a mock-up image, and a selection option 102 for a lid type of a container of the customized cosmetic product and a selection option 103 for a container type may be provided in the remaining region except for the canvas region.

In detail, a selection option for whether the lid type is a pipette type or a button type and a selection option for a color of a lid may be provided as the selection option 102 for the lid type, and a selection option for a color of the container, a selection option for a shoulder addition type of the container, and a selection option for a body length of the container may be provided as the selection option 103 for the container type.

In this case, the container design option may be preferably understood as an option value obtained by extracting a design element including at least one of a size, a proportion, an opening/closing type, and a color of a container by deep-learning a container image of a commercial cosmetic product belonging to a product group that is similar to a product group of the customized cosmetic product (similarity to the product group is greater than or equal to 80%), and combining at least one extracted design element. In addition, all containers of commercial cosmetic products that are similar to the customized cosmetic product may be subject to the deep learning, or a preset number of containers with excellent sales in a descending order of consumer preference may be selected to analyze container images.

In other words, in the step S20, a result of the first interaction of the user for various selection options described above may be preferably implemented in the canvas region 101 in real time to provide a prediction image for the prototype of the customized cosmetic product. More preferably, the prediction image may be provided in the form of a mock-up image (implemented in the same form as an actual product in terms of a size and a proportion) to allow the user to experience a sense of reality about the customized cosmetic product.

Meanwhile, according to another exemplary embodiment of the present invention, before performing the step S20, a response for a product group of the customized cosmetic product to be produced in the user terminal may be obtained by performing a query on the product group of the customized cosmetic product to be produced in the user terminal through the interface.

According to one embodiment of the present invention, the query may be performed by providing a selection option for serum/skin/lotion as a list of customizable product groups through the interface, and sample design elements for a container and a label to be provided in the steps S20 and S30 may be differentiated according to the response for the product group of the customized cosmetic product selected by the user terminal.

For example, according to the embodiment described above, when the user terminal selects a product group for serum, in the steps S20 and S30, at least one sample design for a container design of the serum and a label design of the serum may be provided to provide a selection option for the at least one sample design.

In other words, according to the embodiment of the present invention, the fact that product groups of cosmetic products require mutually different functional designs may be reflected to easily provide design elements corresponding to the product groups, so that an order for the production of the customized cosmetic product may be placed without much difficulty even when a user with a low understanding of the product group of the cosmetic product places the order for the production of the customized cosmetic product.

However, according to another embodiment of the present invention, the platform server may collect information on a target area of the customized cosmetic product from the user terminal through the interface, before performing the step S20, and propose a recommended product group of the customized cosmetic product to be produced in the user terminal by analyzing collected data including at least one of electronic commerce data, real transaction data, and metadata on a social network service for a commercial cosmetic product in the target area, so that product design of the customized cosmetic product may be performed.

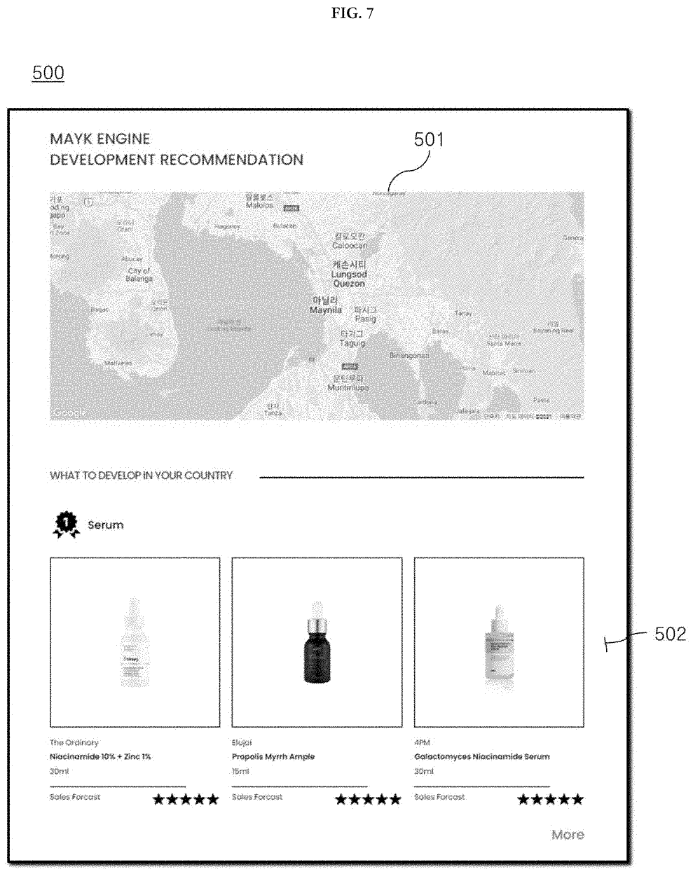

Referring to 500 of FIG. 7, as a specific example of the present invention, a map such as 501 may be provided to collect the information on the target area, which is a marketing target of the customized cosmetic product.

In addition, instead of providing the map such as 501, identification information of the target area (e.g., at least one of a country name, a city name, and a road name) may be directly input by the user terminal to collect the information on the target area, but the present invention is not limited thereto.

In this case, when assuming that the Philippines is set as the target area through the interface shown in 500 of FIG. 7, according to the present invention, information on commercial cosmetic products distributed in the Philippines area may be crawled to propose a product group of a cosmetic product, which is determined to have a high sales power, to the user terminal as the recommended product group.

Meanwhile, as the recommended product group, a product group determined to have the highest selling power by collecting information on a commercial cosmetic product that is frequently mentioned or highly viewed on online-based electronic commerce, offline-based real transaction, and a social network service used by local Filipinos in the target area of the Philippines may be listed.

For example, 502 of FIG. 7 shows an example in which serum is the product group of the cosmetic product with the highest sales power in the Philippines so that the serum is recommended as the customized cosmetic product to be produced in the user terminal.

However, although 502 of FIG. 7 shows a specific embodiment in which the recommended product group is provided as a single product group, at least two product groups of cosmetic products may be provided according to ranking of the product groups with a high sales power, but the present invention is not limited thereto.

Referring again to FIG. 1, when the container design of the customized cosmetic product is determined by performing the step S20, a second decision-making step S30 of determining a label design of the customized cosmetic product by collecting a second interaction value of the user for a label design option of customized cosmetic product through the interface and providing a result of layering a label modeling result corresponding to the second interaction value on the determined container design of the customized cosmetic product may be performed.

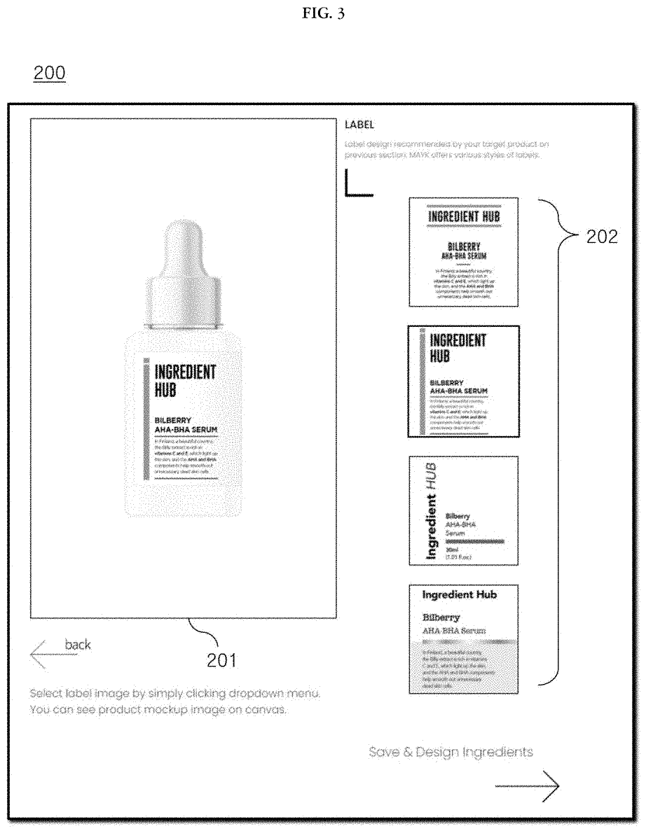

Referring simultaneously to 200 of FIG. 3 to describe the step S30, similarly, in the step S30, a canvas region 201 for implementing a mock-up image of a customized cosmetic product may be provided in one region of the interface, and a selection option 202 for the label design may be provided in a region except for the canvas region 201.

In this case, the selection option 202 for the label design may be understood as an option value obtained by extracting a design element including at least one of a size of the label, a layout between objects constituting the label (including a character and a figure), and a color pattern by performing image analysis on a label design of a commercial cosmetic product belonging to a product group that is similar to a product group of the customized cosmetic product (e.g., similarity of the product group is greater than or equal to 80%), and combining at least one extracted design element.

In addition, although not explicitly shown in the embodiment of 200 of FIG. 3, when one label design is selected by the user terminal, an editing interface for editing at least one object included in the selected label design may be additionally provided to more clearly reflect the needs for a label design pursued by the user, but the present invention is not limited thereto.

Meanwhile, when the label design of the customized cosmetic product is determined by performing the step S30 of FIG. 1, an order referral form generation step S40 of collecting a third interaction value of the user for attribute information of a content of the customized cosmetic product through the interface, and generating an order referral for the production of the customized cosmetic product based on the collected first to third interaction values may be performed.

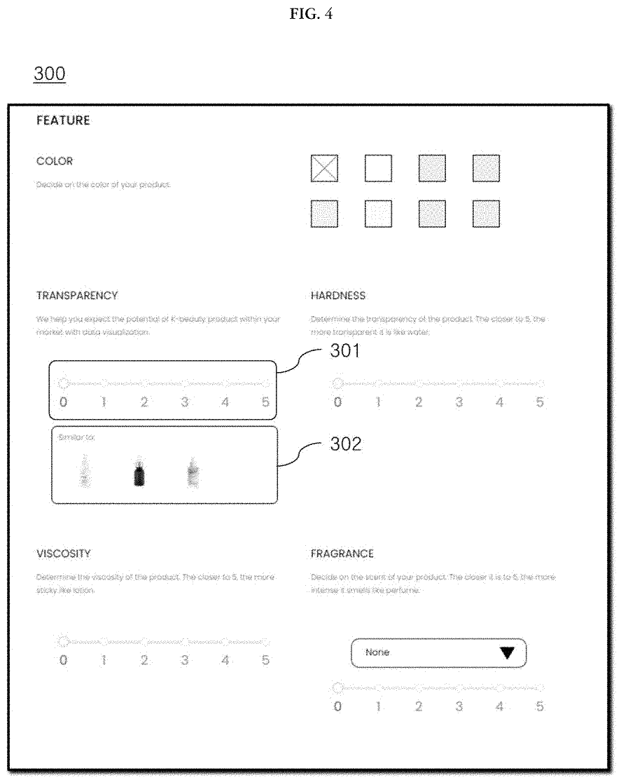

Referring simultaneously to 300 of FIG. 4 to describe the step S40, according to the present invention, when the third interaction value of the user is collected in the step S40, the attribute information of the content of the customized cosmetic product may be provided in a plurality of clusters on the interface.

In detail, the clusters may be based on a result value obtained by collecting attribute information of a content of a commercial cosmetic product evaluated in at least one consumer terminal having an experience of purchasing the commercial cosmetic product, and clustering the collected attribute information.

In this case, the clustering may be understood as an algorithm for classifying data into several groups based on a concept such as similarity. According to the present invention, the clustering for the commercial cosmetic product may be performed by classifying the commercial cosmetic product based on similarity perceived by the user for each item including at least one of a color, transparency, hardness, viscosity, and fragrance of the commercial cosmetic product.

According to one embodiment, when users perceive that a cosmetic product A and a cosmetic product B have similar viscosity, and a cosmetic product D and a cosmetic product E have similar viscosity, a cluster 1 may be generated by the products A and B, and a cluster 2 may be generated by the products C and D, so that the viscosity may have three levels, which are 0, 1, and 2.

Meanwhile, according to the embodiment of 300 of FIG. 4, each of the clusters may include a scale bar 301 as described above, and the scale bar 301 may include a plurality of input fields in which a relative criterion for the attribute information corresponding to the cluster is subdivided into at least one level to collect a third interaction of the user.

The scale bar implemented in the embodiment of 300 of FIG. 4 may include an input field subdivided into a plurality of levels from a level 0.

In this case, in the case of transparency with the scale bar in 300 of FIG. 4, it may be understood that there are five cosmetic product clusters for the transparency, a level 0 of the input field means that the content of the cosmetic product has a transparent attribute, and a level 5 of the input field means that the content of the cosmetic product has an opaque attribute.

As another example, in the case of viscosity with the scale bar, it may be understood that there are five cosmetic product clusters for the viscosity, a level 0 of the input field means that the content of the cosmetic product has a watery attribute similarly to water, and a level 5 of the input field means that the content of the cosmetic product has a high viscosity attribute of a cream formulation.

Meanwhile, according to the present invention, in order to increase a user understanding of the attributes of the customized cosmetic product to be produced upon the production of the customized cosmetic product, commercial cosmetic products having differential attribute information may be displayed as indirect information according to the third interaction of the user with at least one input field.

As indicated by 302 in the embodiment of 300 shown in FIG. 4, a commercial cosmetic product corresponding to the input field selected in the scale bar may be displayed on the interface to guide the user to indirectly predict and view a texture of the customized cosmetic product.

In other words, when a cluster with a scale bar is a cluster for the transparency, and the third interaction of the user with the scale bar is to located at the level 0 in which the content of the cosmetic product has the transparent attribute, according to the present invention, commercial cosmetic products having the transparent attribute may be listed up as the indirect information and provided as shown in 302, so that the user may indirectly predict and view the texture, thereby assisting decision making on an attribute value.

In this case, regarding the commercial cosmetic product provided as the indirect information, a plurality of commercial cosmetic products having similar attributes may be preferably provided as the indirect information rather than providing a single commercial cosmetic product as the indirect information.

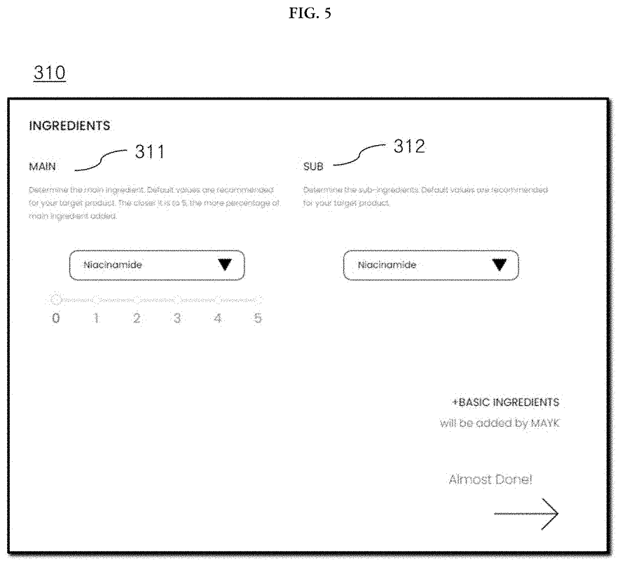

Meanwhile, according to the present invention, as shown in 310 of FIG. 5, when the customized cosmetic product is produced, the attribute information of the commercial cosmetic product may be defined as attributes 310 and 311 for main and sub-ingredients to provide a clustering result according to ingredients, but the present invention is not limited thereto.

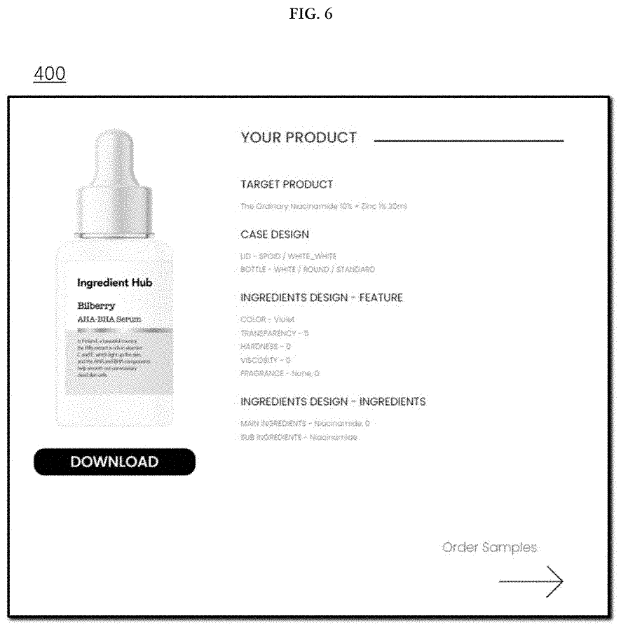

In addition, when all the third interaction values of the user with a clustering item are determined as being collected in the step S40 of FIG. 1, the first to third interaction values of the user may be summarized and provided on the interface as 400 of FIG. 6, and a final mock-up image of the customized cosmetic product may be provided.

Accordingly, characteristics of the cosmetic product customized by the user may be intuitively recognized and viewed in the user terminal before the prototype of the customized cosmetic product is ordered.

In addition, before the prototype of the customized cosmetic product is ordered, a final modeled mock-up image may be downloaded to the user terminal and shared in an SNS account linked to the user terminal for a critical period, so that a reaction for the customized cosmetic product to be customized by the user may be investigated before the prototype is ordered.

Further, in the step S40, an order referral for the customized cosmetic product may be generated based on the first to third interaction values of the user, and the generated order referral may be sent to a manufacturer of the customized cosmetic product, but the present invention is not limited thereto.

In other words, according to one embodiment of the present invention discussed above, the production of the prototype of the customized cosmetic product to be commercialized by the user may be supported based on the sales power of the commercial cosmetic product and the consumer experience of using the commercial cosmetic product, so that a convenience of producing the customized cosmetic product may be increased.

In addition, according to one embodiment of the present invention, even when a user producing a customized cosmetic product does not have expertise about cosmetic product production or cosmetic product attributes, the production of the customized cosmetic product to be produced by the user may be supported by clearly recognizing the needs of the user.

Further, according to one embodiment of the present invention, the customizing scheme with the high actual product reproducibility may be proposed by providing the mock-up image of the customized cosmetic product according to the selection input of the user terminal when the order for producing the prototype of the customized cosmetic product is performed in the user terminal, so that user satisfaction of using a service may be significantly improved.

Although the above description has been made with reference to specific embodiments and drawings, various modifications and changes can be made by those skilled in the art from the above description.

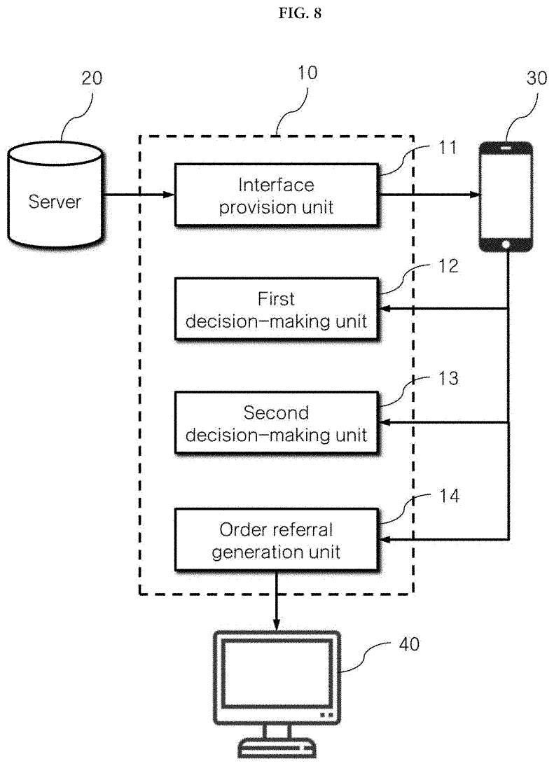

Next, referring to FIG. 8, FIG. 8 is a block diagram of an apparatus 10 for producing a customized cosmetic product according to one embodiment of the present invention.

As shown in FIG. 8, the apparatus 10 for producing the customized cosmetic product according to the present invention may preferably include an interface provision unit 11, a first decision-making unit 12, a second decision-making unit 13, and an order referral generation unit 14.

In detail, when a user terminal 30 is connected to a platform server 20 configured to support the production of the customized cosmetic product, the interface provision unit 11 may function to provide an interface for the production of the customized cosmetic product to the user terminal 30.

In this case, the interface provision unit 11 may be understood as being capable of performing all functions performed in the step S10 of FIG. 1, and according to the present invention, the needs for the customized cosmetic product to be produced by a user may be clearly collected by performing the functions of the interface provision unit 11.

Meanwhile, the first decision-making unit 12 may collect a first interaction value of a user for a container design option of the customized cosmetic product through the interface provided to the user terminal 30, and provide a container modeling result of the customized cosmetic product corresponding to the first interaction value.

In other words, the first decision-making unit 12 may be understood as being capable of performing all functions performed in the step S20 of FIG. 1, so that decision making of the user for determining a container design of the customized cosmetic product may be assisted.

Meanwhile, next, when the container design of the customized cosmetic product is determined by the first decision-making unit 12, the second decision-making unit 13 may function to collect a second interaction value of the user for a label design option of the customized cosmetic product through the interface, and provide a result of layering a label modeling result corresponding to the second interaction value on the determined container design of the customized cosmetic product.

In other words, the second decision-making unit 13 may be understood as being capable of performing all functions performed in the step S30 of FIG. 1, and according to the present invention, decision making of the user for determining a label design of the customized cosmetic product may be assisted by performing the functions of the second decision-making unit 13.

Next, the order referral generation unit 14 may function to collect a third interaction value of the user for attribute information of a content of the customized cosmetic product through the interface, and generate an order referral for the production of the customized cosmetic product based on the first to third interaction values.

In this case, the generated order referral may be transmitted to a manufacturer terminal 40 of the customized cosmetic product, which is pre-contracted with the platform server 20.

In other words, the order referral generation unit 14 may be understood as being capable of performing all functions performed in the step S40 of FIG. 1, and according to the present invention, even when the user producing the customized cosmetic product by performing the functions does not have expertise about cosmetic product production or cosmetic product attributes, the production of the customized cosmetic product to be produced by the user may be supported by clearly recognizing the needs of the user.

Although the above description has been made with reference to specific embodiments and drawings, various modifications and changes can be made by those skilled in the art from the above description.

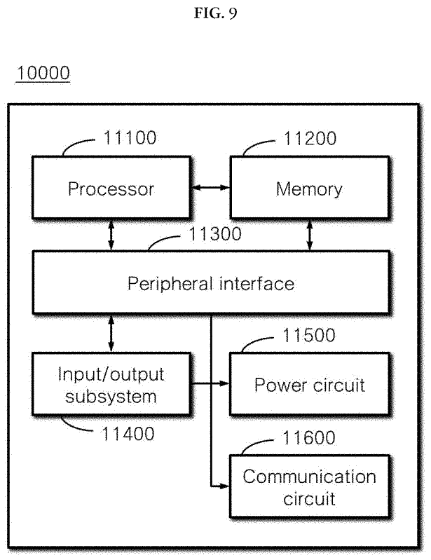

Next, referring to FIG. 9, FIG. 9 shows one example of an internal configuration of a computing device according to one embodiment of the present invention. In the following description, redundant descriptions of the embodiment corresponding to the above descriptions for FIGS. 1 to 8 will be omitted.

As shown in FIG. 9, a computing device 10000 may at least include at least one processor 11100, a memory 11200, a peripheral interface 11300, an input/output (I/O) subsystem 11400, a power circuit 11500, and a communication circuit 11600. In this case, the computing device 10000 may correspond to a user terminal A connected to a tactile interface device A, or correspond to a computing device B described above.

The memory 11200 may include, for example, a high-speed random access memory, a magnetic disk, an SRAM, a DRAM, a ROM, a flash memory, and a non-volatile memory. The memory 11200 may include a software module, an instruction set, or other various data required for an operation of the computing device 10000.

In this case, access to the memory 11200 from other components of the processor 11100, the peripheral interface 11300, or the like may be controlled by the processor 11100.

The peripheral interface 11300 may couple an input and/or output peripheral device of the computing device 10000 to the processor 11100 and the memory 11200. The processor 11100 may execute the software module or the instruction set stored in the memory 11200 to perform various functions for the computing device 10000 and process data.

The I/O subsystem 11400 may couple various input/output peripheral devices to the peripheral interface 11300. For example, the I/O subsystem 11400 may include a controller for coupling the peripheral device, such as a monitor, a keyboard, a mouse, a printer, or a touch screen or a sensor if necessary, to the peripheral interface 11300. According to another aspect, input/output peripheral devices may be coupled to the peripheral interface 11300 without passing through the I/O subsystem 11400.

The power circuit 11500 may supply a power to all or some of the components of the terminal. For example, the power circuit 11500 may include a power management system, at least one power source such as a battery or an alternating current (AC), a charging system, a power failure detection circuit, a power converter or inverter, a power status indicator, and any other components for generating, managing, or distributing a power.

The communication circuit 11600 may use at least one external port to enable communication with other computing devices.

Alternatively, as described above, the communication circuit 11600 may include an RF circuit, if necessary, to transmit and receive an RF signal, also known as an electromagnetic signal, thereby enabling the communication with other computing devices.

The above embodiment of FIG. 9 is merely an example of the computing device 10000, and a computing device 11000 may have a configuration or arrangement that omits some of the components shown in FIG. 9, further includes an additional component that is not shown in FIG. 9, or combines at least two components. For example, a computing device for a communication terminal in a mobile environment may further include a touch screen, a sensor, and the like in addition to the components shown in FIG. 9, and the communication circuit 11600 may include a circuit for RF communication in various communication schemes (such as Wi-Fi, 3G, LTE, Bluetooth, NFC, and Zigbee). The components that may be included in the computing device 10000 may be implemented as hardware, software, or a combination of both hardware and software including at least one integrated circuit specialized in signal processing or an application.

The methods according to the embodiment of the present invention may be implemented in the form of program instructions that may be executed through various computing devices, and may be recorded in a computer-readable medium. In particular, a program according to the present embodiment may be configured as a PC-based program or an application dedicated to a mobile terminal. An application to which the present invention is applied may be installed in a user terminal through a file provided by a file distribution system. For example, the file distribution system may include a file transmission unit (not shown) for transmitting the file according to a request from the user terminal.

The device described above may be implemented as a hardware component, a software component, and/or a combination of the hardware component and the software component. For example, the devices and components described in the embodiments may be implemented by using at least one general purpose computer or special purpose computer such as a processor, a controller, an arithmetic logic unit (ALU), a digital signal processor, a microcomputer, a field programmable gate array (FPGA), a programmable logic unit (PLU), a microprocessor, or any other device capable of executing and responding to an instruction. The processing device may execute an operating system (OS) and at least one software application executed on the operating system.

In addition, the processing device may access, store, manipulate, process, and generate data in response to the execution of the software. In some cases, one processing device is described as being used for convenience of understanding. However, it will be appreciated by those skilled in the art that the processing device may include a plurality of processing elements and/or a plurality of types of processing elements. For example, the processing device may include a plurality of processors or one processor, and one controller. In addition, other processing configurations such as a parallel processor may be possible.

The software may include a computer program, a code, an instruction, or a combination of at least one thereof, and may configure the processing device to operate as desired or instruct the processing device independently or collectively. In order for the software and/or data to be interpreted by the processing device or to provide an instruction or data to the processing device, the software and/or data may be permanently or temporarily embodied in any type of machine, component, physical device, virtual equipment, computer storage medium, or device. The software may be distributed over computing devices, which are connected through a network, so as to be stored or executed in a distributed manner. The software and data may be stored in at least one computer-readable recording medium.

The method according to the embodiment may be implemented in the form of a program instruction that may be executed through various computer mechanisms, and may be recorded in a computer-readable medium. The computer-readable medium may include a program instruction, a data file, a data structure, and the like, alone or in combination with each other. The program instruction recorded on the medium may be specially designed and configured for the embodiment, or may be known and available to those skilled in the art of computer software. An example of the computer-readable recording medium includes a magnetic media such as a hard disk, a floppy disk, and a magnetic tape, an optical media such as a CD-ROM and a DVD, a magneto-optical media such as a floptical disk, and a hardware device specially configured to store and execute a program instruction such as a ROM, a RAM, and a flash memory.

An example of the program instruction includes a high-level language code that may be executed by a computer by using an interpreter or the like, as well as a machine language code generated by a compiler. The hardware device may be configured to operate as at least one software module to perform the operations of the embodiments, and vice versa.

Although the above description has been made with reference to specific embodiments and drawings, various modifications and changes can be made by those skilled in the art from the above description. For example, even when the described techniques are performed in an order that is different from the described manner, and/or the described components such as systems, structures, devices, and circuits are coupled or combined in a form that is different from the described manner, or replaced or substituted by other components or equivalents, appropriate results may be achieved. Therefore, other implementations, other embodiments, and equivalents to the claims are also within the scope of the appended claims.

What is claimed is:

1. A method for supporting production of a customized cosmetic product, which is implemented in a computing device including at least one processor and at least one memory for storing instructions that are executable by the processor, the method comprising:
an interface provision step of providing an interface for the production of the customized cosmetic product to a user terminal when the user terminal is connected to a platform server configured to support the production of the customized cosmetic product;
a first decision-making step of determining a container design of the customized cosmetic product by collecting a first interaction value of a user for a container design option of the customized cosmetic product through the interface provided to the user terminal and providing a container modeling result of the customized cosmetic product corresponding to the first interaction value;
a second decision-making step of determining, when the container design of the customized cosmetic product is determined, a label design of the customized cosmetic product by collecting a second interaction value of the user for a label design option of the customized cosmetic product through the interface and providing a result of layering a label modeling result corresponding to the second interaction value on the determined container design of the customized cosmetic product; and
an order referral generation step of collecting a third interaction value of the user for attribute information of a content of the customized cosmetic product through the interface, and generating an order referral for the production of the customized cosmetic product based on the collected first to third interaction values.

2. The method of claim 1, wherein, when the third interaction value is collected, the attribute information of the content of the customized cosmetic product is provided in a plurality of clusters on the interface, and
each of the clusters includes a scale bar for guiding a relative criterion for the attribute information, and displays a commercial cosmetic product having similar attribute information as indirect information in response to a third interaction of the user with the scale bar.

3. The method of claim 2, wherein the clusters are based on a result value obtained by collecting attribute information of a content of a commercial cosmetic product evaluated in at least one consumer terminal having an experience of purchasing the commercial cosmetic product, and clustering the collected attribute information.

4. The method of claim 3, wherein the scale bar includes an input field in which the relative criterion for the attribute information is subdivided into at least one level, and
commercial cosmetic products having differential attribute information are displayed as the indirect information according to the third interaction of the user with at least one input field to support decision-making on an attribute value of the customized cosmetic product produced in the user terminal.

5. The method of claim 1, wherein the platform server is configured to:
obtain a response for a product group of the customized cosmetic product to be produced in the user terminal by performing a query on the product group of the customized cosmetic product to be produced in the user terminal through the interface, before performing the first decision-making step; and
differentiate sample designs for the container design and the label design to be provided in the first decision-making step and the second decision-making step according to the response for the product group of the customized cosmetic product.

6. The method of claim 5, wherein the platform server is configured to:
collect information on a target area of the customized cosmetic product from the user terminal through the interface, before performing the first decision-making step; and
propose a recommended product group of the customized cosmetic product to be produced in the user terminal by analyzing collected data including at least one of electronic commerce data, real transaction data, and metadata on a social network service for a commercial cosmetic product in the target area.

7. The method of claim 1, wherein the container design option provided through the interface in the first decision-making step includes an option value obtained by extracting a design element including at least one of a size, a proportion, an opening/closing type, and a color of a container by analyzing a container image of a commercial cosmetic product belonging to a product group that is similar to a product group of the customized cosmetic product, and combining at least one extracted design element.

8. The method of claim 1, wherein the label design option provided through the interface in the second decision-making step includes an option value obtained by extracting a design element including at least one of a size of a label, a layout between objects constituting the label, and a color pattern by analyzing a label design of a commercial cosmetic product belonging to a product group that is similar to a product group of the customized cosmetic product, and combining at least one extracted design element.

9. An apparatus for supporting production of a customized cosmetic product, which is implemented with a computing device including at least one processor and at least one memory for storing instructions that are executable by the processor, the apparatus comprising:
an interface provision unit for providing an interface for the production of the customized cosmetic product to a user terminal when the user terminal is connected to a platform server configured to support the production of the customized cosmetic product;
a first decision-making unit for determining a container design of the customized cosmetic product by collecting a first interaction value of a user for a container design option of the customized cosmetic product through the interface provided to the user terminal and providing a container modeling result of the customized cosmetic product corresponding to the first interaction value;
a second decision-making unit for determining, when the container design of the customized cosmetic product is determined, a label design of the customized cosmetic product by collecting a second interaction value of the user for a label design option of the customized cosmetic product through the interface and providing a result of layering a label modeling result corresponding to the second interaction value on the determined container design of the customized cosmetic product; and
an order referral generation unit for collecting a third interaction value of the user for attribute information of a content of the customized cosmetic product through the interface, and generating an order referral for the production of the customized cosmetic product based on the collected first to third interaction values.

10. A computer-readable recording medium for storing instructions that allows a computing device to:
an interface provision step of providing an interface for the production of the customized cosmetic product to a user terminal when the user terminal is connected to a platform server configured to support the production of the customized cosmetic product;
a first decision-making step of determining a container design of the customized cosmetic product by collecting a first interaction value of a user for a container design option of the customized cosmetic product through the interface provided to the user terminal and providing a container modeling result of the customized cosmetic product corresponding to the first interaction value;
a second decision-making step of determining, when the container design of the customized cosmetic product is determined, a label design of the customized cosmetic product by collecting a second interaction value of the user for a label design option of the customized cosmetic product through the interface and providing a result of layering a label modeling result corresponding to the second interaction value on the determined container design of the customized cosmetic product; and
an order referral generation step of collecting a third interaction value of the user for attribute information of a content of the customized cosmetic product through the interface, and generating an order referral for the production of the customized cosmetic product based on the collected first to third interaction values.
